(19) United States
(12) Patent Application Publication
(10) Pub. No.: US 2015/0283656 A1
(43) Pub. Date: Oct. 8, 2015

(54) PROCESS FOR PRODUCING A TURBINE WHEEL

(71) Applicant: BORGWARNER INC., Auburn Hills, MI (US)

(72) Inventors: Frank Scherrer, Frankenthal (DE); Menno Roder, Kirchheimbolanden (DE); Gerald Schall, Bobenheim-Roxheim (DE); Juergen Strelbitski, Orbis (DE); Michael Loewenberg, Weierhof/Bolanden (DE); Stefan Eisinger, Bornheim (DE); Adnan Adilovic, Darmstadt (DE); Dominik Kuss, Weisenheim am Berg (DE); Christian Cudel, Strasbourg (FR)

(21) Appl. No.: 14/437,392

(22) PCT Filed: Oct. 22, 2013
(86) PCT No.: PCT/US2013/066022

§ 371 Date: Apr. 21, 2015

(30) Foreign Application Priority Data
Nov. 2, 2012 (DE) 102012021580.0

(51) Int. Cl. B23P 15/00; B22D 25/02; B22D 21/02; F01D 5/02; C22C 14/00

(52) U.S. Cl. CPC B23P 15/006; F01D 5/02; C22C 14/00; B22D 21/022; B22D 25/02; F05D 2230/42

(57) ABSTRACT

A process for producing a turbine wheel (10), including the following process steps: casting a bar-shaped primary material (3); treating the primary material (3) in a hot isostatic pressing process (HIP process); dividing the HIP-treated primary material (3) into primary shaped parts (4 to 8); forging a blank (9) from each of the primary shaped parts (4 to 8); and creating, in particular milling, a turbine wheel (10) from the blank (9).

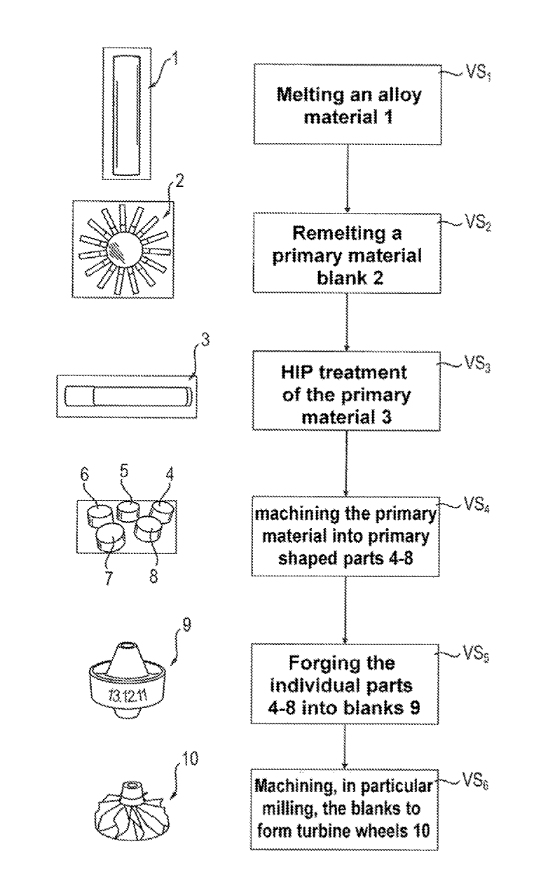

The invention relates to a process for producing a turbine wheel as claimed in claim 1.

It is known to produce turbine wheels by casting. In the case of cast components of this type, however, the formation of defects during the casting process cannot be ruled out. If such components are subjected to a strong temperature variation during operation, for example in an exhaust-gas turbocharger, stress peaks can occur at these defects. In the case of very brittle materials, these stress peaks lead to critical states which can lead to the failure of the components. In the case of cast turbine wheels, the formation of voids is a known effect. If titanium aluminide is used as the base material for a turbine wheel, a very brittle material is used. Here, it is necessary to completely avoid defects—primarily voids and porosities.

It is an object of the present invention, therefore, to provide a process for producing a turbine wheel which is free from defects, in particular from voids.

This object is achieved by the features of claim 1. According to the invention, the turbine wheel is subjected to an HIP process after the casting of primary material, as a result of which most of the voids can be removed. An HIP process is understood to mean hot isostatic pressing, in which the material is subjected to a pressing operation at high temperatures. Should defects still be present after the HIP process, they are removed in the subsequent forging step or forging process. Defects are removed completely by the high temperature and the deformation caused by the influence of force during forging. The “HIP—Forging” combination therefore makes it possible to also eliminate last defects and therefore to considerably increase the service life of the turbine wheel, which preferably consists of titanium aluminide.

The dependent claims contain advantageous developments of the invention.

The process according to the invention for producing a turbine wheel, preferably for use in an exhaust-gas turbocharger, will be explained in more detail hereinbelow with reference to the single figure of the drawing.

Accordingly, in a first process step VS₁, a suitable alloy material 1, in particular titanium aluminide, is melted. In process step VS₂, a primary material blank 2 which can be seen in the figure is melted, giving a plurality of bar-shaped primary materials, such as, in the example of the figure, fifteen bars.

In process step VS₃, each of these primary materials 3 or each of these bars 3 is subjected to an HIP treatment, by means of which a multiplicity of defects, in particular voids, which may be present can already be eliminated.

In process step VS₄, the thus treated primary materials or bars 3 are divided, for example cut up, so that a plurality of individual parts, in the example five individual parts 4 to 8, are formed, depending on the length of the bars 3.

In process step VS₅, a blank 9 can be forged from each of these individual parts 4 to 8, where, in this forging operation, voids or defects which may still be present can be eliminated to the greatest possible extent.

In process step VS₆, the blank 9 is given the finished shape of the turbine wheel 10 by machining, in particular a milling operation.

In addition to the above written disclosure of the invention, reference is hereby explicitly made to the drawing, to supplement said written disclosure.

### LIST OF REFERENCE SIGNS

1 Alloy material
2 Primary material/blank
3 Primary material/bar
4 to 8 Individual parts/primary shaped parts
9 Forged blank
10 Finished turbine wheel

1. A process for producing a turbine wheel (10), comprising the following process steps:
casting a bar-shaped primary material (3);
treating the primary material (3) in a hot isostatic pressing process (HIP process);
dividing the HIP-treated primary material (3) into primary shaped parts (4 to 8);
forging a blank (9) from each of the primary shaped parts (4 to 8); and
creating a turbine wheel (10) from the blank (9).

2. The process as claimed in claim 1, wherein the primary material (3) is divided by a machining operation.

3. The process as claimed in claim 1, wherein the primary material (3) is produced from titanium aluminide.

4. The process as claimed in claim 1, wherein the primary material (3) is divided by sawing or water jet cutting.

5. A process for producing a turbine wheel (10), comprising the following process steps:
casting a bar-shaped primary material (3);
treating the primary material (3) in a hot isostatic pressing process (HIP process);
dividing the HIP-treated primary material (3) into primary shaped parts (4 to 8);
forging a blank (9) from each of the primary shaped parts (4 to 8); and
milling a turbine wheel (10) from the blank (9).

6. The process as claimed in claim 5, wherein the primary material (3) is divided by a machining operation.

7. The process as claimed in claim 5, wherein the primary material (3) is divided by sawing or water jet cutting.

8. The process as claimed in claim 1 wherein the primary material (3) is produced from titanium aluminide.
